(19) United States
(12) Patent Application Publication
(10) Pub. No.: US 2021/0056644 A1
(43) Pub. Date: Feb. 25, 2021

(54) Golf Mobile Application System

(71) Applicant: Doug Karo, Weymouth, MA (US)

(72) Inventor: Doug Karo, Weymouth, MA (US)

(21) Appl. No.: 16/999,186

(22) Filed: Aug. 21, 2020

Related U.S. Application Data
(60) Provisional application No. 62/890,899, filed on Aug. 23, 2019.

(51) Int. Cl. G06Q 50/00; G06Q 10/02; G06Q 20/10; G06Q 30/06; G06Q 20/32; G06F 16/23; A63B 57/00

(52) U.S. Cl. CPC G06Q 50/01; G06Q 10/02; G06Q 20/108; G06Q 30/0631; G06Q 50/14; G06Q 30/0641; G06Q 20/326; G06F 16/2379; A63B 57/00; G06Q 30/0633

(57) ABSTRACT

A system for managing in-person golf contests for use on a mobile device using a computing platform to provide a service by which an individual can participate in an in-person game of golf for prize money. The user downloads the application, creates a user account, chooses the location and opponents and submits a cash amount to be distributed to the winner. The system further allows for the creation of a profile, social networking between users, scheduling and booking of golf course facilities, gaming competitions, viewing local restaurants and bars and selling and buying of goods.

### CROSS REFERENCE TO RELATED APPLICATION

This application claims the benefit of and takes priority from U.S. Provisional Patent Application Ser. No. 62/890,899 filed on Aug. 23, 2019, the contents of which are herein incorporated by reference.

### BACKGROUND OF THE INVENTION

### Field of the Invention

The present system and method pertains to a mobile application for golf and more particularly to social networking with other golfers, entering and participating in in-person golf contests with local players, and booking and schedule use of golf course facilities.

### Description of the Related Art

Currently, there exists a few types of phone applications or websites for golf play or sports betting with other users. Most of these applications allow users to either bet on games played by others or allows users to schedule and play games with each other, but without the ability to bet. Some of these applications and websites have relatively expensive fees required to be submitted before participation is allowed. Others have a high cost to purchase the mobile application or require a fee to become a member or create an account.

Some applications allow for users to play against their friends while playing on separate courses by submitting their individual scores from their perspective locations. This creates the issue of a lack of accountability and regulation for determining accuracy of scores imputed and determining the winner of a match. Other applications allow for betting during a match between users, but does not have the ability to schedule and reserve game time on courses. Others still do not have the social aspect where users cannot communicate or share information via a profile or through recommended bars or restaurants. Finally, there are golf betting websites and mobile applications that allow users to bet on the outcome of games played by others, including professionals, but not on games played themselves.

### SUMMARY OF THE INVENTION

The instant system and method, as illustrated herein, are clearly not anticipated, rendered obvious, or even present in any of the prior art mechanisms, either alone or in any combination thereof. Thus the several embodiments of the instant apparatus are illustrated herein.

In one embodiment, the instant system contemplates a novel mobile application system for golf for use on a mobile device.

The instant system further discloses a novel mobile application system for golf wherein one embodiment allows the user to select a golf match to participate in. A home course and preferred away courses may be selected by the user. In one embodiment the user can choose to enter a match at any of the home or away courses. A further objective of the instant system allows a user to view affiliate clubs available for play.

The instant system further discloses a novel mobile application system for golf wherein one embodiment a user can schedule and reserve time on a golf course.

The instant system also discloses a novel mobile application system for golf that allows the users to interact by creating a profile with personal and golf related information that can be shared with other users of the novel system.

The instant system also discloses a novel mobile application system for golf that allows users to view user-preferred restaurants and bars and to suggest their preferred restaurants and bars.

It is also an objective of the instant system to disclose a novel mobile application system for golf that allows users to post and view pictures.

It is yet another objective of the instant system to disclose a novel mobile application system for golf wherein a user can buy or sell their golf items.

It is also an objective of the instant system to disclose a novel mobile application system for golf that allows users to write comments, post content and view the mobile application blog.

It is also an objective of the instant system to disclose a novel mobile application system for golf that allows a user to view current matches taking place and view live score updates. A user can further view past match outcomes and scores.

Another objective of the instant system is a novel mobile application system for golf that allows a user to enter a golf contest with other users for a designated cash prize amount. The users submit the cash amount designated before game play begins. At the end of the match, the winner's account is credited with the total sum of the cash submitted by all players in their match. In one embodiment, specific cash amounts are designated by “flight.” A George Washington flight indicates a game with a cash cost of $1.00-5.00 per player. A Hamilton flight indicates a game with a cash cost of $10 per player. A Jackson flight indicates a game with a cash cost of $20 per player, the Grant $50 per player, and the Ben Franklin $100 or more per player.

It is also an objective of the instant system to disclose a novel mobile application system for golf that allows a user to transfer funds from their bank to the instant system. It is a further objective of the instant system to allow a user to transfer funds from the user's account in the instant system to their preferred bank account.

It is an additional objective of the instant system to disclose a novel mobile application system for golf featuring components and modules related to Match Creation/Opt-In and information pertaining to individual golfers for analysis related to demographics and match data. It is a further objective of the instant system to disclose a novel mobile application system for golf featuring components and modules related to User Match requests and Acceptance.

It is also an objective of the instant system to disclose a novel mobile application system for golf that utilizes a golfer matching module. It is also an objective of the instant system to disclose a golfer matching module which utilizes an Artificial Intelligence based Neural Network. It is also an objective of the instant system to disclose a novel mobile application system wherein the Artificial Intelligence based Neural Network uses a series of data points recorded and tracked by the system.

It is also an objective of the instant system to disclose a novel mobile application system wherein series of data points may include, but are not limited to hole by hole score, handicap, home club and club statistics like par and slope, match type played most frequently, action vs non-action based matches, handicap level of partners and opponents, frequency of matches, location of match, availability of golfer and match time, personal preferences of all golfers, Nassau wager preferences and account balance. The output of the Artificial Intelligence based Neural Network may include, but is not limited to golfer matches to foursomes or twosomes including club hosting recommendations.

The instant system also discloses a novel mobile application system for golf that is easy to use. The instant system further discloses a novel mobile application system for golf that is inexpensive. A further objective of the instant system is a novel mobile application system for golf that is environmentally friendly. The instant system also discloses a novel mobile application system for golf that is efficient.

There has thus been outlined, rather broadly, the more important features of the mobile application system for golf in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description, and/or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present system in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

Advantages of the present system will be apparent from the following detailed description of exemplary embodiments thereof, which description should be considered in conjunction with the accompanying drawings, in which: Having thus described the system in general terms, reference will now be made to the accompanying drawings, which are not necessarily drawn to scale, and wherein:

FIG. 1 illustrates a flow diagram of an exemplary embodiment of the Golf mobile application system.

FIG. 2 illustrates one embodiment of an exemplary computing system, wherein the systems and methods disclosed herein may be implemented using one or more computer systems.

FIG. 3 illustrates a flow diagram of an exemplary embodiment of the Golf mobile application system login, profile and contest participation process.

FIG. 4 illustrates a flow diagram of an exemplary embodiment of the Golf mobile application system contest participation process.

FIG. 5 illustrates a flow diagram of an exemplary embodiment of the Golf mobile application system out-of-town contest.

FIG. 6 illustrates a flow diagram of an exemplary embodiment of the Golf mobile application system leaderboard process.

FIG. 7 illustrates a flow diagram of an exemplary embodiment of the Golf mobile application system affiliate club process.

FIG. 8 illustrates a flow diagram of an exemplary embodiment of the Golf mobile application system group golfing process.

FIG. 9 illustrates a flow diagram of an exemplary embodiment of the Golf mobile application system social membership process.

FIG. 10 illustrates a flow diagram of an exemplary embodiment of the Golf mobile application system profile creation and editing process.

FIG. 11 illustrates a flow diagram of an exemplary embodiment of the Golfer Matching process.

FIG. 12 illustrates a flow diagram of an exemplary embodiment of the Neural Net cloud server that analyzes Golfer Data during the Golfer Matching process.

FIG. 13 illustrates a flow diagram of an exemplary embodiment of tournament wagers within the Lynksin System.

FIG. 14 illustrates a loading screen displayed upon opening the mobile app.

FIG. 15 illustrates a loading screen displayed upon opening the mobile app.

FIG. 16 illustrates a loading screen displayed upon opening the mobile app.

FIG. 17 illustrates a loading screen displayed upon opening the mobile app.

FIG. 18 illustrates an exemplary embodiment of a login and registration screen.

FIG. 19 illustrates the “Discover Matches” page displayed after login.

FIG. 20 illustrates a secondary view of the “Discover Matches” page.

FIG. 21 illustrates an exemplary embodiment of a signup page to play with other users.

FIG. 22 illustrates a notification screen shoring other players who have opted in to play in a match created by a host.

FIG. 23 illustrates an exemplary embodiment of the golfer profile.

FIG. 24 illustrates an alternate view of the golfer profile.

FIG. 25 illustrates an alternate view of the golfer profile.

FIG. 26 illustrates the “Discover Golfers” page.

FIG. 27 illustrates the “Discover Clubs” page.

FIG. 28 illustrates a detailed information screen for a selected club.

FIG. 29 illustrates the first step of creating a match selecting a club.

FIG. 30 illustrates the second step selecting the date and time for a match.

FIG. 31 illustrates the third step choosing players for a match.

FIG. 32 illustrates a half full match with open spots.

FIG. 33 illustrates the wager selection screen for setting up a match.

FIG. 34 illustrates an alternate view of the wager selection screen.

FIG. 35 illustrates an alternate view of the wager selection screen.

FIG. 36 illustrates a notification page for an invitation to join a created match.

FIG. 37 illustrates successfully created match notification screen.

FIG. 38 illustrates notification that a match has been created that meets a user's Golfer Preferences.

FIG. 39 illustrates an exemplary embodiment of a detailed description page for a created match.

FIG. 40 illustrates a notification page after successfully joining a match.

FIG. 41 illustrates a match results page.

FIG. 42 illustrates an alternate embodiment of a match results page

FIG. 43 illustrates an alternate embodiment of a match results page

FIG. 44 illustrates an alternate embodiment of a match results page

FIG. 45 illustrates an overview of Golfer Controls.

FIG. 46 illustrates record of past matches and winnings.

FIG. 47 illustrates Lynksin Golf Club Leaderboard.

### DETAILED DESCRIPTION OF THE SEVERAL EMBODIMENTS

The detailed description set forth below in connection with the appended drawings is intended as a description of presently preferred embodiments of the system and does not represent the only forms in which the present system may be constructed and/or utilized. The description sets forth the functions and the sequence of steps for constructing and operating the system in connection with the illustrated embodiments.

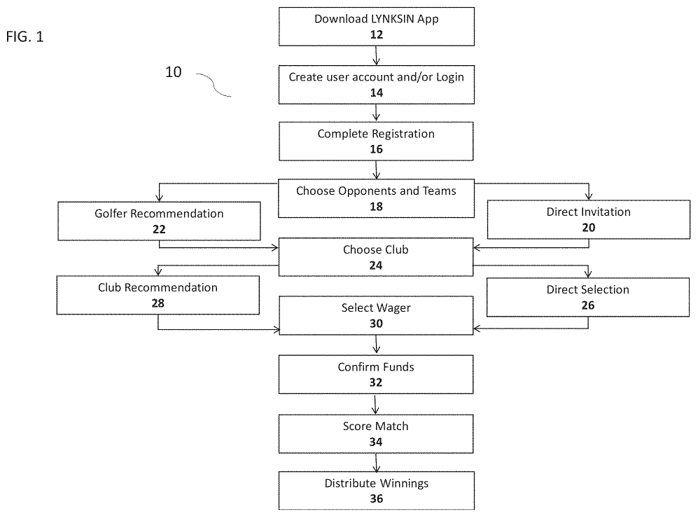

FIG. 1 illustrates a flow diagram of an exemplary embodiment of the Golf mobile application system 10. Initially at step 12, a user may download the mobile application system for golf 10 onto a mobile device. Once the mobile application system for golf is downloaded, at step 14 the user is prompted to either login to the system with an existing account or create an account for new users. If the user is a new user the system will prompt them to complete the new user registration by inputting personal information, demographics, golf preferences, and skill indication metrics at step 16. If a user account already exists the user only needs to login and move to step 18. Next, a user can begin setting up a match at step 18 by choosing others golfers to participate in the match. There are two ways a user can add golfers to a match. First, at step 20 a user can add golfers to the match directly. Alternatively at step 22, the system will suggest other Lynksin golf users based on information unique to the user profiles, hereinafter explained further. The players can then determine how to organize teams for the match or elect to play individually. After finalizing the golfers and teams, the system prompts a user to choose a location and club for the match at step 24. Club selection follows a similar process as golfer selection and can also be done in two ways. First at step 26, a user can select a club directly. Alternatively at step 28, a user can select a club from a list of clubs recommended by the system. The system will recommend clubs to a user based on location data and golfer preference for each of the players. Once a course is chosen a user is then prompted to select a wager type and amount for the match 30. The system uses a fail-safe measure when entering wagers to ensure all players have sufficient funds in their Lynksin account to participate based on the selected wager at step 32.

Thus, if a golfer does not have the requisite funds, the system will not allow the match to begin. Once the system confirms all the participating golfers are eligible the match can begin. Players can keep match score in real time by entering their scores hole-by-hole. Alternatively, a user can enter the score for the whole match for all players once completed at step 34. Each player then reviews the scores and then either makes necessary changes or authenticates that the scores are correct. A photo of the scorecard can also be uploaded to the Match Results page. After the match is completed and all layers have confirmed the scores, the system automatically distributes funds to the winner's Lynksin account at step 36.

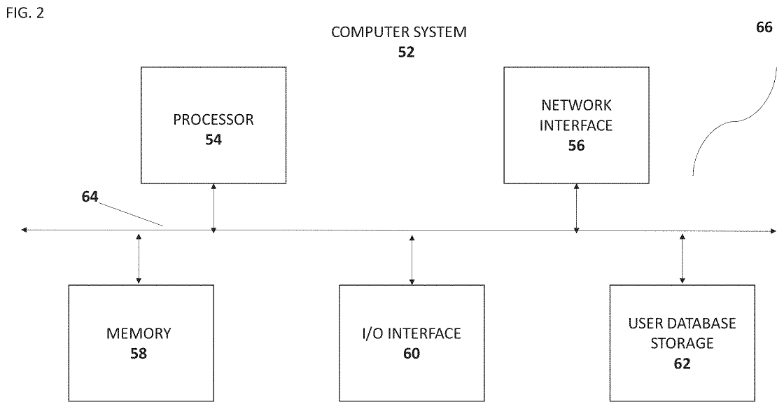

FIG. 2 illustrates an exemplary embodiment of a computer system 52, wherein the systems and methods disclosed herein may be implemented using one or more computer systems. As shown, the computer system 52 can include one or more processors 54 which can control the operation of the computer system 52. The processor(s) 54 can include any type of microprocessor or central processing unit (CPU), including programmable general-purpose or special-purpose microprocessors and/or any one of a variety of proprietary or commercially available single or multi-processor systems. The computer system 52 can also include one or more memories 58, which can provide temporary storage for code to be executed by the processor(s) 54 or for data acquired from one or more users, storage devices, and/or databases.

The memory 58 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies. The various elements of the computer system 52 can be coupled to a bus system. The bus system can be any one or more separate physical busses, communication lines/interfaces, and/or multi-drop or point-to-point connections, connected by appropriate bridges, adapters, and/or controllers.

The computer system 52 can also include one or more network interface(s) 56, one or more input/output (IO) interface(s) 60, and one or more storage device(s) 62. The network interface(s) 56 can enable the computer system 52 to communicate with remote devices (e.g., other computer systems) over a network, and can be, for example, remote desktop connection interfaces, Ethernet adapters, and/or other local area network (LAN) adapters. The IO interface(s) 60 can include one or more interface components to connect the computer system 52 with other electronic equipment.

For example, the IO interface(s) 60 can include high speed data ports, such as USB ports, 1394 ports, etc. Additionally, the computer system 52 can be accessible to a human user, and thus the IO interface(s) 60 can include displays, speakers, keyboards, pointing devices, and/or various other video, audio, or alphanumeric interfaces. The storage device(s) 62 can include any conventional medium for storing data in a non-volatile and/or non-transient manner. The storage device(s) 62 can thus hold data and/or 5 instructions in a persistent state (i.e., the value is retained despite interruption of power to the computer system 52). The storage device(s) 62 can include one or more hard disk drives, flash drives, USB drives, optical drives, various media cards, and/or any combination thereof and can be directly connected to the computer system 52 or remotely connected thereto, such as over a network.

In addition, not all of the illustrated elements need to be located on or in the same physical or logical machine. Rather, the illustrated elements can be distributed in nature, e.g., using a server farm or cloud-based technology. Exemplary computer systems include conventional desktop computers, workstations, minicomputers, laptop computers, tablet computers, PDAs, mobile phones, and the like. Although an exemplary computer system is depicted and described herein, it will be appreciated that this is for sake of generality and convenience. In other embodiments, the computer system may differ in architecture and operation from that shown and described here.

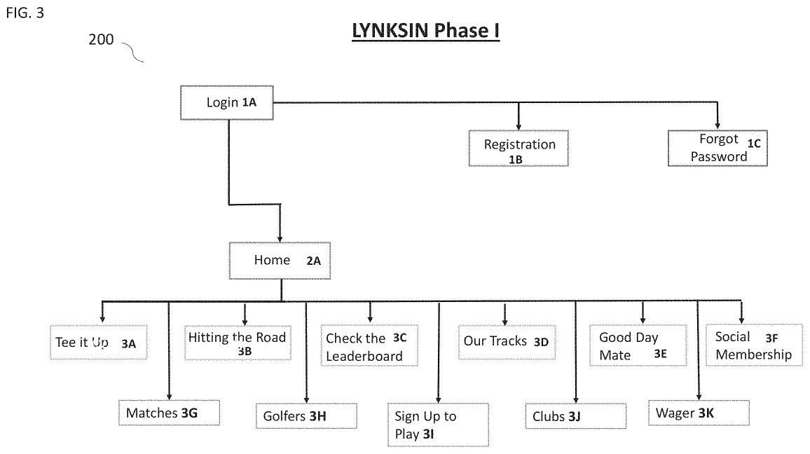

FIG. 3 illustrates a flow diagram of an exemplary embodiment of the Golf mobile application system login, profile and contest participation process 200. Initially at step LA, a user may login to the golf mobile application system 200 or create a user account and password at step 1B. If the user already has an account, the user at step 1C can follow the steps to retrieve their account and create a new password. Once the information has been entered, at step 1B, the user is prompted to login at step LA. Once logged in, the user will be brought to the home screen 2A.

From this step, the User can choose to choose to select options for entering a contest at step 3A, options for entering an out-of-town contest at step 3B, check the leaderboard at step 3C, affiliated courses at step 3D, setting up group events at step 3E, or social membership at step at step 3F. A user can also navigate to view Matches at step 3G, view other Golfers in the Lynksin network at step 3H, Sign up to play with others at step 3I, view Clubs at step 3J, or submit up a Wager at step 3K.

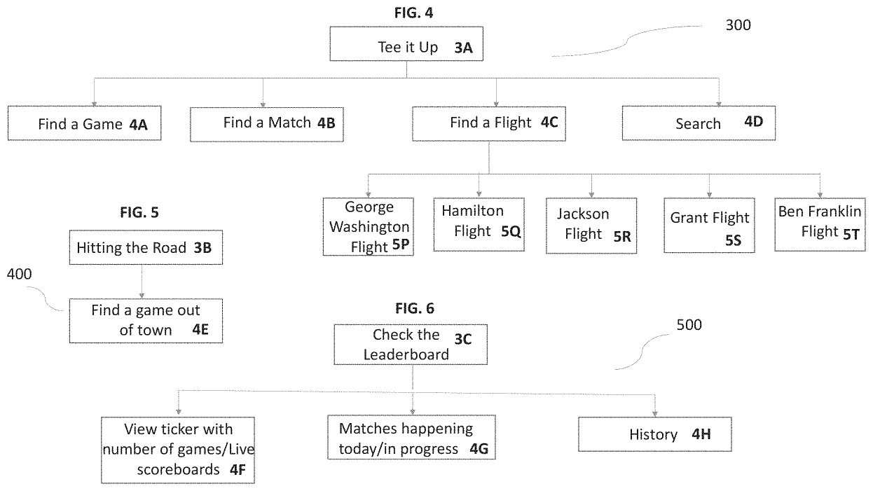

FIG. 4 illustrates a flow diagram of an exemplary embodiment of the Golf mobile application system contest participation process 300. An existing user can select “Tee it up” at step 3A from the Home screen at step 2A. From the “Tee it Up” screen a user can then select Find a Game at step 4A, Find a Match at step 4B, Find a Flight at step 4C, or Search at step 4D. IF find a game is selected at 4A a user will be able to view available games in the nearby area. If Find a match at step 4B is selected, a user can search for players to join at a specific course. If find a flight at step 4C is selected a user will be prompted to select one of five flights each with variable entry costs. The George Washington flight cost is between one and five dollars at step 5P. The Hamilton flight cost is ten dollars as step 5Q. The Jackson flight cost is twenty dollars as step 5R. The Grant flight cost is fifty dollars at step 5S. The Ben Franklin flight cost is one-hundred dollars or more at step 5T.

FIG. 5 illustrates a flow diagram of an exemplary embodiment of the Golf mobile application system out-of-town contest 400. A user can select “Hitting the Road” at step 3B from the Home Screen at step 2A. Next, a user may select “Find a game out of town” at step 4E. At this step a user can enter their current location and search for an available games or matches in their current area.

FIG. 6 illustrates a flow diagram of an exemplary embodiment of the Golf mobile application system leaderboard process 500. A user can select “Check the leaderboard” at step 3C. Next a user may choose to view the number of current games pending and see live scores at step 4F, view matches happening today or matches that are in progress at step 4G, or view gaming history at step 4H.

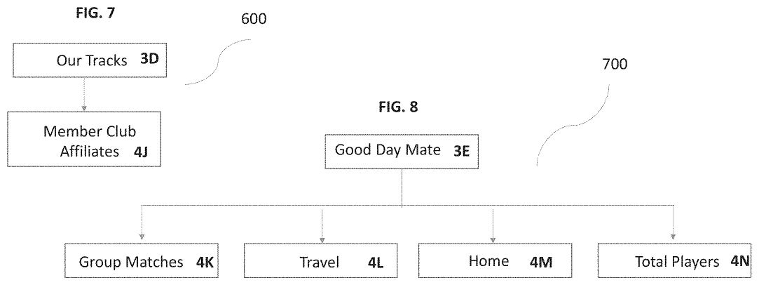

FIG. 7 illustrates a flow diagram of an exemplary embodiment of the Golf mobile application system affiliate club process 600. A user can access this screen by selecting “Our Tracks” at step 3D. From there, a user can select “Member Club Affiliates” at step 4J. A user will next be able to view a list of Golf Clubs affiliated with the instant mobile application.

FIG. 8 illustrates a flow diagram of an exemplary embodiment of the Golf mobile application system group golfing process 700. The user can select “Good Day Mate” 3E. From there a user can choose between group matches at step 4K, Travel at step 4L for matches while traveling, Home at step 4M for matches while at the selected home course, or Total Players at 4N to view total available players nearby.

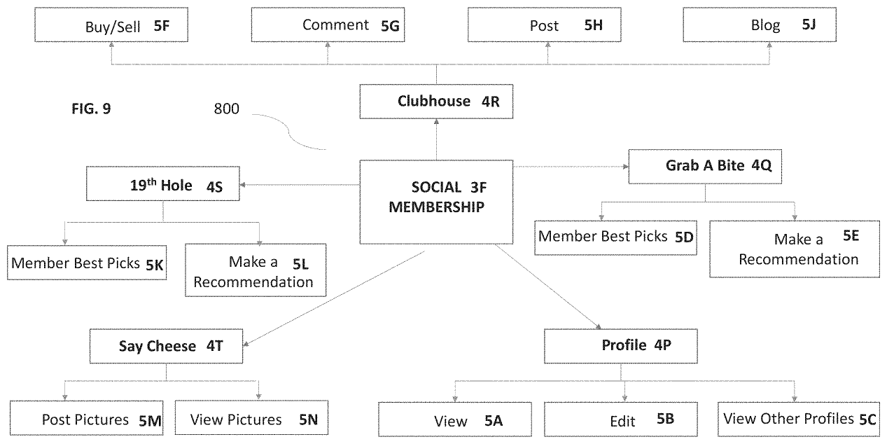

FIG. 9 illustrates a flow diagram of an exemplary embodiment of the Golf mobile application system social membership process 800. From this step a user can choose between “Profile” at step 4P, “Grab a Bite” at step 4Q, “Clubhouse” at step 4R, “19th Hole” at step 4S, and “Say Cheese” at step 4T.

If a user selects “Profile” at step 4P the user can then further choose to view their profile at 5A, edit their profile at step 5B, or view other member profiles at step 5C.

If a user selects “Grab a Bite” at step 4Q the user can then further choose to view member recommended restaurants at step 5D, or to make their own recommendation for a restaurant at step 5E.

If a user selects “Clubhouse” at step 4R, the user can then further choose to buy or sell their gold related products at step 5F, leave comment at step 5G, post content at step 5H, or view the LYNKSIN blog at step 5J.

If a user selects “19^{th} Hole at step 4S, the user can then further choose to view member recommended restaurants at step 5K or to make their own recommendation for a restaurant at step 5L. Again, if a user selects “Say Cheese” at step 4T, the user can then further choose to upload pictures at step 5M or view other user's posted pictures at step 5N.

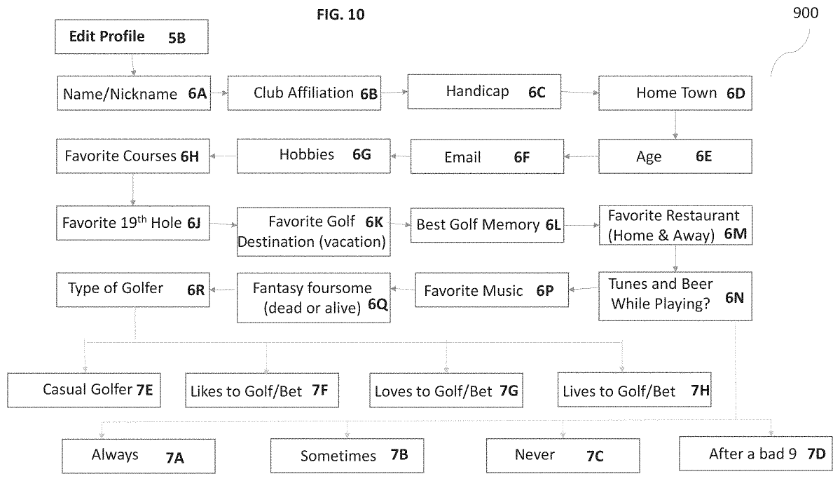

FIG. 10 illustrates a flow diagram of an exemplary embodiment of the Golf mobile application system profile creation and editing process 900. If a user chooses to edit their profile at step 5B, they will then be prompted to enter various information as prompted at each step. At step 6A a user will be asked to input their name and preferred nickname. Next, a user will be asked to list all club affiliations they may have at step 6B. At step 6C, a user is prompted to enter their handicap. This information is required before a user can sign up for a match.

A user is then prompted to enter their home town information at step 6D followed by their age at step 6E and their email at step 6F. Next, a user is asked to input their hobbies at step 6G, favorite courses at 6H, favorite after golf drinking location at step 6J, and favorite golf destination while traveling at 6K. Afterwards, a user is asked to provide their favorite golf memory at 6L and their favorite restaurants both at home and away at step 6M. Following the previous prompts, a user is asked if they like to listen to music and/or drink while playing golf. The user is provided with four choices: “Always” at 7A, “Sometimes” at 7B, “Never” at 7C, and “After a bad 9” at 7D.

Next a user is asked to list their favorite music at 6N and four of their fantasy golf opponents, alive or deceased, at 6P. Finally, a user is asked what type of golfer they believe they are along with their betting preferences. A user who does not like to bet would select “casual golfer” at 7E. If a user likes to bet on occasion, they would select “likes to golf/bet” at 7F. A user likes to bet regularly, they would select “loves to golf/bet” at 7G. If a user likes to bet on all matches, they would select “lives to golf/bet” at 7H.

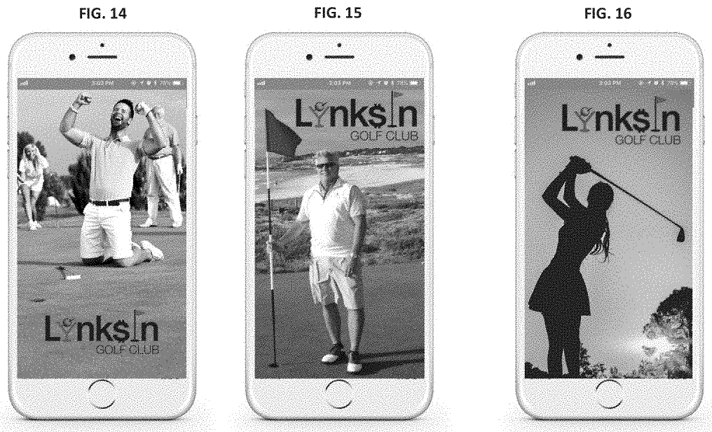

FIGS. 14-17 illustrate various embodiments of a loading screen displayed when a user first opens the Lynksin Golf Club Mobile App.

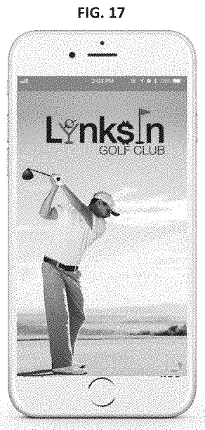

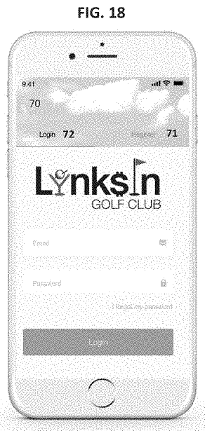

FIG. 18 illustrates a preferred embodiment of a registration screen for a user to login or create a profile and begin participating in the Lynksin Golf Club network. Once a user has downloaded the application, a login/register screen 70 is shown and the user is prompted to select the “Register” tab and create a new account 71 or login with an existing account 72. The registration screen prompts the user to input personal information to create the new golfer profile and choose a password. Continuing the registration process, the system prompts the user to input data for golf related statistical indicators handicap, average score, and frequency of play.

The user can also include various golf demographic data including favorite club, frequent club statistics such as par and slope, most frequently played match type, preferred play time, wager preferences. Even further, the user can include personal data such as marital status, employment status, whether or not the user has children, and any other potentially relevant factor. The golfer successfully joins the Lynksin Golf Club network once the above information is input. The system then uses this information to match like-minded and closely skilled Lynksin members with each other to quickly facilitate competitive and enjoyable matches.

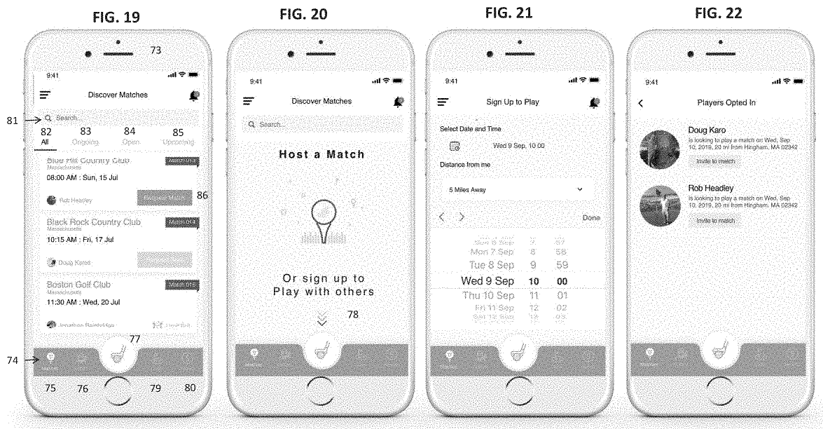

FIG. 19-22 illustrates an exemplary embodiment of the system login and user home page. After a successful login or registration, the system displays a first screen 73 with tabs 74 along the lower edge of the screen a user can select to execute the various activities within the app. Each section tied to a particular function of the system will be later described in greater detail. Fist, a user can select the Matches tab 75 to browse and filter potential matches, host a new match, or “opt in” to play with others based on date, time, and geographic preferences. Next, the Golfers tab 76 displays other Lynksin Golf Club members along with some basic identifying information, location, and handicap. The system suggests other users under the “Discover Golfers” section and is described later in greater detail.

A central, circular icon displaying a golf club and ball 77 leads a user to a screen to “opt in” to sign up to play 78 with other Lynksin members. The Clubs tab 79 allows a user to search for specific clubs by keyword, find nearby clubs, track past played clubs, and maintain a list of favorite clubs. Finally, the Results tab 80 tracks a golfer's past matches including both standard golf indicators and any wager outcomes.

The matches tab 75 is automatically displayed upon login or registration. First, the system displays a “Discover Matches” page listing all matches created by other golfers. A user can browse matches from this page and filter the matches further based on their user preferences. A search bar 81 at the top of the screen allows a golfer to search for a specific match by golfer name, course name, or other identifying key words.

Additional inputs under the search bar can filter potential matches by all 82 available matches, ongoing 83 matches, open 84 matches, and upcoming 85 matches. The match list includes details for each match about the club chosen by the match host, date and time for the match, and a Request Match button 86 for a golfer to accept a potential match.

Once a golfer identifies a desired match, golfers select the Request Match button 86 to “Opt In” to a potential match. The system then sends notifications FIG. 22 to the match host identifying the requesting golfers and match. The host can then either accept the request and add the golfer to the match or deny the request. Alternatively, golfers can sign up to play with others within the Lynksin Golf Club network from the Matches Tab FIG. 21. The user will elect certain match preferences including Availability, Match Type, Wager Type and Amount, and Distance Willing to Travel to better connect similarly skilled and like-minded golfers. The system will use these preferences and golf match data associated with each unique golfer profile to then suggest potential matches to Lynksin members. This information helps a match creator find other potential golfers to play against and displays them under the “Discover Golfers” page, described further below.

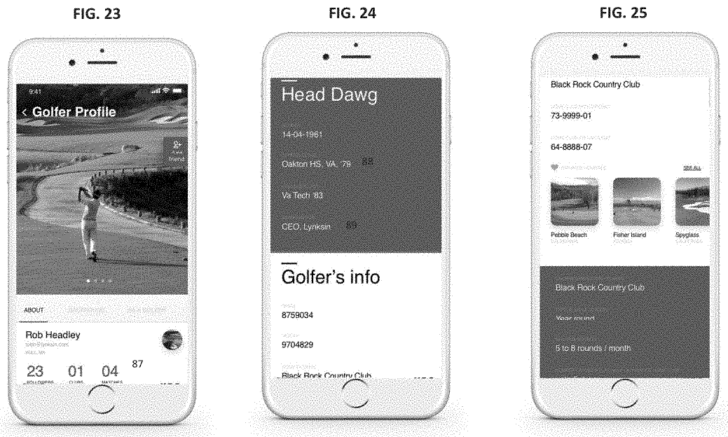

FIGS. 23-25 illustrate a preferred embodiment of user information displayed in the Golfer Profile. A user can choose to include information for a number of relevant factors such as educational Lynksin followers and matches 87, graduation years 88, and occupation 89. The app also tracks a multitude of common golf indicators relevant to match pairings such as scores, handicap, play frequency, favorite club, etc. The user profile will also display a variety of demographic data to further improve the golfer matching and search process. A golfer can use the app to find other potential matches based on the factors listed above.

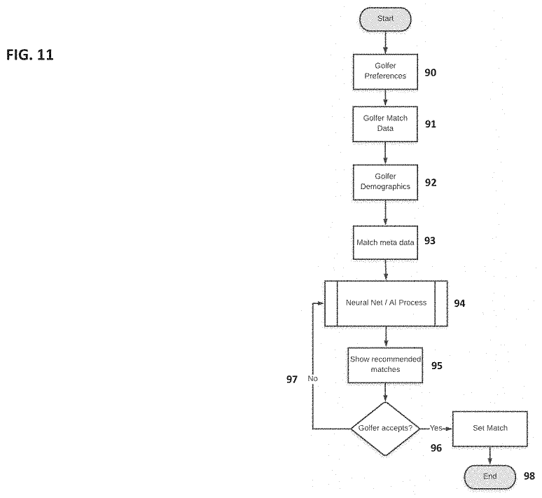

FIG. 11 illustrates a preferred flow for the golfer matching process. The system makes use of an Artificial Intelligence based Neural Network utilizing relevant data tracked by the system and managed in an Internet cloud service. The system proactively look at user profiles and compare them to other users in order to find the most favorable matches. The goal of the app is to include as much data as possible that could potentially be relevant to how enjoyable and competitive a match will be. Initially, the system analyzes Golfer Preferences 90, Golfer Match Data 91, Golfer Demographics 92, and Match Meta Data 93 to begin determining potential matches. The system then analyzes the data at step 94 and provides recommended matches to the user at step 95. If the golfer wishes to accept 96 the match, the process ends 98 and the user can continue to the wager phase of the match creation process, described later. If the golfer does not accept the match 97, the system returns to step 94 and recommends new potential matches to the golfer. This process can continue until all spots until all spots in a match are filled.

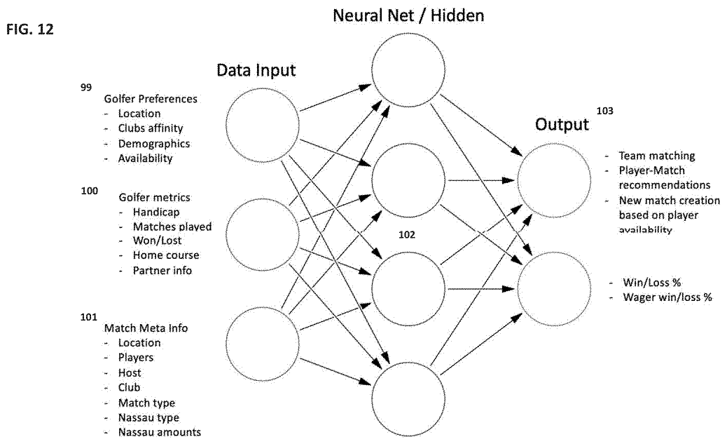

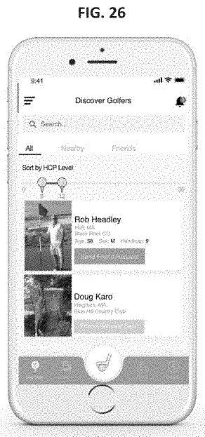

FIGS. 12 & 26 illustrates the Neural Net analyses process carried out at step 94 of FIG. 11 and suggesting golfers. Golfer Preference Data 99 analyzed by the system includes location, Club Affinity, Demographics, and Availability. Golfer Metric Data 100 analyzed by the system includes Handicap, Matches Played, Win/Loss ratio, Home Course, and Partner Info. The Match Meta Data 101 includes Location, Players, Host, Club, Match Type, Nassau Type, and Nassau Amounts. The system then analyzes this data at step 102 and outputs 103 potential Team Matching, Player-Match Recommendations, New matches based on Availability, Win/loss percentage, and Wager percentage. The system compiles all of this data to provide the most appropriate matches for Lynksin Golf Club Members. Additionally, the system may suggest potential golfers to other user as in “Discover Golfers” FIG. 26. Golfers can be further filtered by handicap, location, age, and mutual friends. A user can send Other Golfers friend requests to facilitate future matches or follow another user's matches.

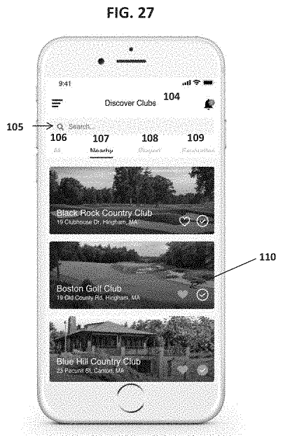

FIGS. 27 & 28 illustrate how a user can search for clubs, maintain a list of their favorite and past clubs, and view relevant information related to any club. When a user selects the Clubs tab, the system displays a page labeled “Discover Clubs” 104. From here, a user can directly look up clubs using a search bar 105 at the top of the Discover Clubs page. Alternatively, tabs below the search bar allow a user to further filter clubs by all clubs 106, clubs within a geographic area by selecting nearby 107, past clubs 108, and favorite clubs 109.

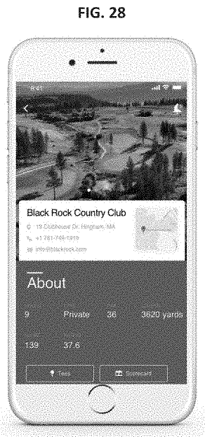

In order to add a club to the user's favorite list, the user simply selects the heart icon 110 associated with the favorite club. FIG. 28 shows a detailed information screen for a club after selection from the list in FIG. 27. From this page a golfer can view details about a course such as type holes, type, par, yardage, slope, and user rating. A user can add the club to their favorites, view past matches at the selected club, or browse the course by hole.

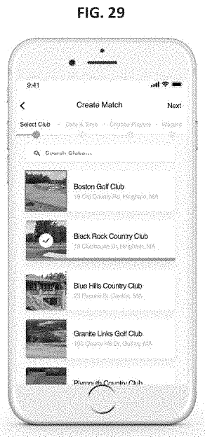

FIGS. 29-32 illustrate the match creation process a user can initiate from one of the three previously described areas of the present system. After the user has decided to host a match from the matches tab, selected golfers to play against from the “Discover Golfers” page, or selected a club from the “Discover Clubs” page, the match creation process can begin. The first step, shown at FIG. 29, is to select the desired course.

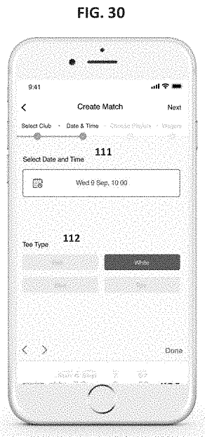

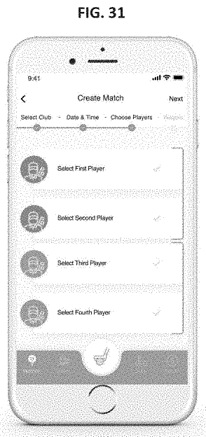

Next in FIG. 30 a user inputs logistic details for the match including date & time 111 and tees the match will be played from 112. Subsequently in FIG. 31, the match creator then selects other Lynksin members to add to the match. Players selected form the “Discover Golfers” page will be displayed at 113 as shown in FIG. 32. For any remaining spots 114, the match creator can directly add players or alternatively add players that have been suggested the Lynksin network. The creator could also elect to allow the Lynksin system to automatically fill any remaining spots from golfers who have opted in to play with matching preferences, as previously described.

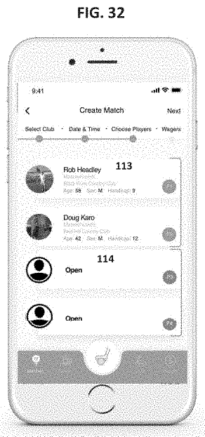

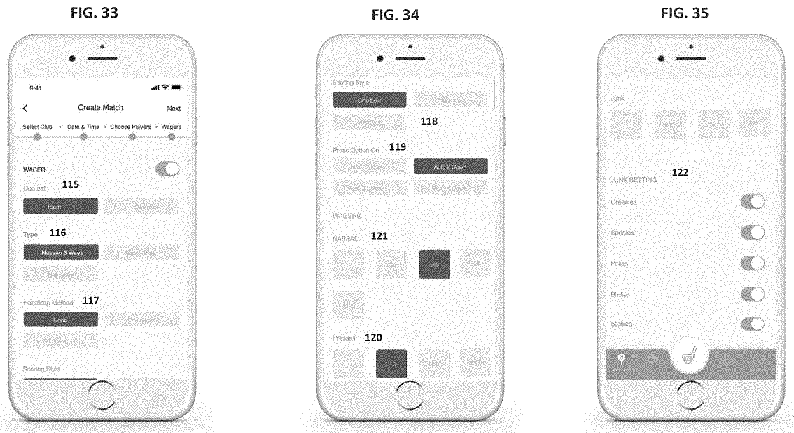

FIGS. 33-35 illustrate how a match creator would set the wager parameters for a given match created in the previously described process. The match can be set up as either in teams or as an individual competition 115. The wager type 116, if desired, can be set from this page as well from a list including but not limited to Nassau 3 Ways, match play, net score, presses, and junk betting. More wager types may be added in the future. The match creator can set the handicap 117 for the match and the scoring type 118. The wager parameters can vary and give the match creator and player great freedom during the match. The creator can turn on presses and elect when to put them into effect at 119 and set their amount at 120. The amount of the Nassau wager can be set at 121. The users can also select from a listing of common junk bets 122 to use throughout a match.

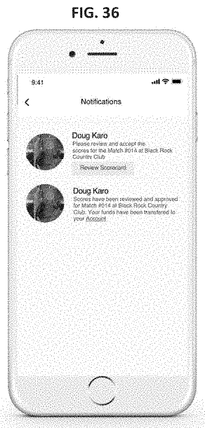

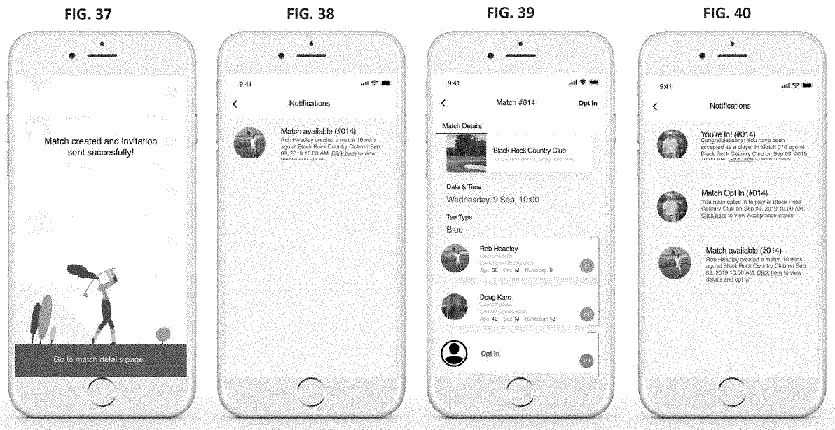

FIGS. 36-40 illustrate the system immediately after match creation. The match creator will receive a notification FIG. 37 confirming that the match has been created. Any users invited directly by the match creator receive a notification prompting them to accept or deny the invitation FIG. 36. A user can set the system to send a notification when another user creates a match that fits the Golfer Preferences linked to their Lynksin profile and Opt In to an open position FIG. 38.

Users are allowed to elect to receive a notification with the match details prompting the user to view the match and Opt In to play if any matches are created that fit the Golfer Preferences associated with their Lynksin Profile. FIG. 39 shows a details relating to the match with players already opted in and any remaining spots. A user requests to join an open match and the match creator receives a notification detailing any golfers wishing to join the match. FIG. 40 shows a user notification page who Opted In to a match with an open spot and who was accepted to join the match.

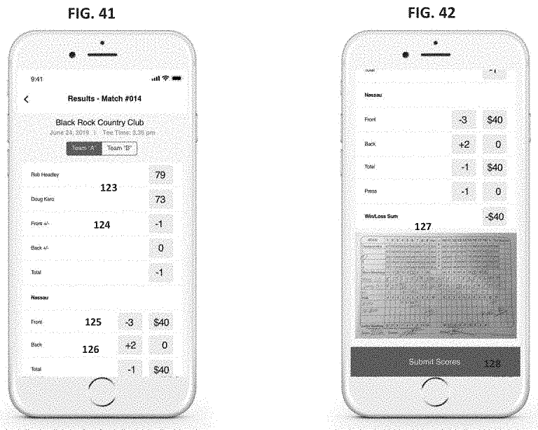

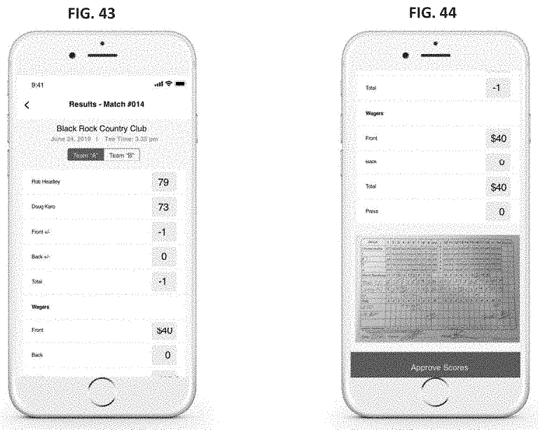

FIGS. 41-44 illustrate an example of a match recap between two individual players. Users can input and review scores 123, handicap 124, wager parameters and outcomes 125, front or back score 126, and the match scorecard 127. All users then authenticate the match results and in this page using the approve scores button 128 and the system then distributes winnings. FIGS. 43-44 show an alternate view.

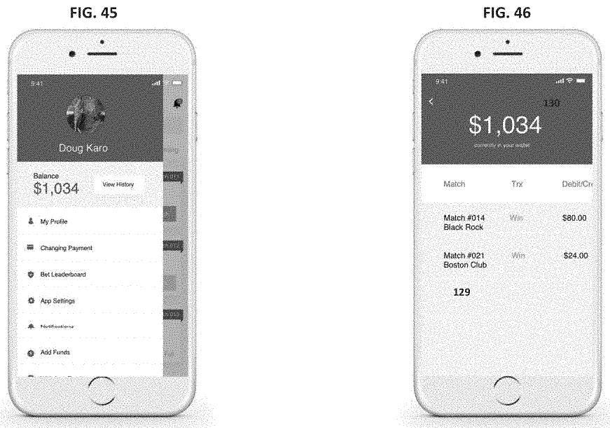

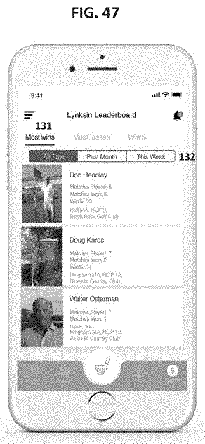

FIGS. 45 & 46 illustrate a user menu that can be used to navigate the application and view past match winnings. The user can make changes to their profile or any payments. The system maintains a record of all past matches 129 and keeps a running total of funds in the user account 130. All wagers and winnings are managed through the system here to streamline the matches and associated wagers.

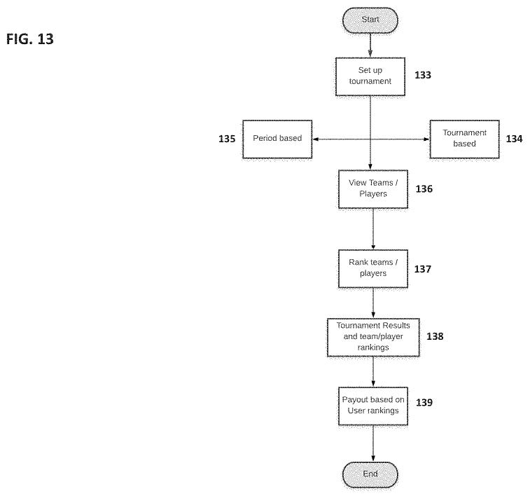

FIGS. 13 & 47 illustrate a preferred embodiment of the Lynksin leaderboard and tournament wager. Data is tracked among all golfers in the Lynksin network and displayed. A user can filter golfer statistics by type of statistic 131 or time period 132. From here, users can submit wagers based on exiting matches and golfer statistics. Other potential uses for the leaderboards include tournament invitations for top players and cash prizes for users leading in a particular metric. FIG. 13 relates to setting up a tournament within the system at step 133 using statistics from the leaderboards.

The tournament can either be strictly tournament based 134 or can be period based 135. Lynksin users will elect one of these and proceed to view participating players and teams at step 136. Users then rank 137 the participating players and teams based on how they believe the rankings will stand at the end of the tournament. The results are tallied at step 138 and the system pays out all winnings at step 139 based on the final rankings.

What is claimed is:

1. A mobile application system for golf configured to allow a user to enter golf contests, socialize, schedule and reserve golf course time, and post and view content, the mobile application system for golf comprising;
a processor, a memory and a plurality of storage devices;
the novel mobile application system for golf when executed performs the steps of:
creating a username and password;
logging in with username and password;
selecting a match to enter into;
transferring funds according to the match fees;
entering real-time scores of the match; and
collecting the prize money upon winning.

2. The mobile application system for golf of claim 1, configured to keep score of real-time golf matches, collect entry fees and distribute prize money to winners.

3. The mobile application system for golf of claim 1, configured to match up multiple users for in-person golf matches.

4. The mobile application system for golf of claim 1, configured to have users enter real-time golf scores to determine the winner of a match.

5. The mobile application system for golf of claim 1, configured to have a user winner of a match collect prize money by transferring funds from the system to a bank account of choice.

6. A mobile application system for golf configured to allow a user to enter golf contests, socialize, schedule and reserve golf course time, and post and view content, the mobile application system for golf comprising;
a processor, a memory and a plurality of storage devices;
the novel mobile application system for golf when executed performs the steps of:
creating a username and password;
logging in with username and password;
selecting a course to play at;
reserving a time to play;
selecting opponents to play against; and
inviting opponents to compete.

7. The mobile application system for golf of claim 6, configured to allow for searching nearby golf courses and selecting an available time to play.

8. The mobile application system for golf of claim 6, configured to allow for searching of available nearby opponents and inviting of those opponents to a match at a nearby golf course at a reserved time.

9. A mobile application system for golf configured to allow a user to enter golf contests, socialize, schedule and reserve golf course time, and post and view content, the mobile application system for golf comprising;
a processor, a memory and a plurality of storage devices;
the novel mobile application system for golf when executed performs the steps of:
creating a username and password;
logging in with username and password;
creating a profile;
selecting a profile to view;
posting original content;
selecting content of others to view;
posting items for sale;
selecting items for purchase;
viewing recommended bars and restaurants; and
recommending bars and restaurants.

10. The mobile application system for golf of claim 9, configured to allow for the creation of a personal profile by answering a series of questions and for viewing of profiles created by other users.

11. The mobile application system for golf of claim 9, configured to allow for upload of images, posting of content, and viewing images and posted content of others.

12. The mobile application system for golf of claim 9, configured to allow for listing items for sale and for viewing and purchasing of items listed for sale by others.

13. The mobile application system for golf of claim 9, configured to determine location of a user and subsequently provide a list of local courses, available opponents, restaurants and bars.
